(19) United States
(12) Patent Application Publication
(10) Pub. No.: US 2020/0324253 A1
(43) Pub. Date: Oct. 15, 2020

(54) A Graphene-Based Membrane

(71) Applicants: National University of Singapore, Singapore (SG); Grafoid Inc., Kingston (CA)

(72) Inventors: Kian Ping Loh, Singapore (SG); Kiran Kumar Manga, Singapore (SG); Janardhan Balapanuru, Singapore (SG)

(21) Appl. No.: 16/770,978

(22) PCT Filed: Jan. 15, 2019
(86) PCT No.: PCT/SG2019/050021

§ 371 Date: Jun. 9, 2020

(30) Foreign Application Priority Data
Jan. 15, 2018 (SG) 10201800333W

(51) Int. Cl. B01D 71/02; B01D 71/38; B01D 61/00; B01D 67/00; B01D 69/14; B01D 69/02; C01B 32/19; C01B 32/198; C01B 32/194

(52) U.S. Cl. CPC B01D 71/021; C01P 2004/20; B01D 61/002; B01D 67/0011; B01D 67/0079; B01D 67/0013; B01D 69/148; B01D 67/0095; B01D 69/02; C01B 32/19; C01B 32/198; C01B 32/194; B01D 2323/04; B01D 2323/12; B01D 2323/36; B01D 2325/04; B01D 2325/38; B01D 71/38

(57) ABSTRACT

There is provided a graphene-based membrane, particularly a free-standing one, comprising: a plurality of partially oxidised few-layer graphene (POFG) sheets; and a polymer for interconnecting the plurality of POFG sheets in a matrix. In the preferred embodiment, the polymer is water-based polymer. There is also provided a method of forming the free-standing graphene-based membrane; and a method of preparing the POFG sheets, comprising: electrochemically exfoliating graphite to form intercalated graphite powder; expanding the intercalated graphite powder to form few-layer graphene (FG); and partially oxidizing the FG with an oxidizing agent for a pre-determined period of time to form POFG sheets.

### TECHNICAL FIELD

The present invention relates to a graphene-based membrane, particularly a free-standing graphene-based membrane, and a method of forming the same.

### BACKGROUND

In the drive to alleviate water shortage caused by a growing population, seawater desalination and wastewater treatment are one of the most valuable technologies for mankind today. Forward osmosis (FO) process has attracted growing interest in energy-efficient water desalination and waste water treatment technologies since the process is driven mainly by osmotic pressure, thus requiring less energy input and has a lower fouling tendency compared to reverse osmosis (RO). The main drawback is the need to have a high concentration draw liquid, but FO can find niche applications in the treatment of crude oil/water mixtures, concentration of fruit juices and biofuel wastewater treatments. Since these processes are not suitable for RO because of fouling tendencies when these concentrated liquids are purged through a RO cartridge, FO membranes which can combine the advantages of high water flux and high ion rejection are heavily demanded.

The ability of graphene oxide (GO) to form lamellar membrane with chemically tunable interfacial properties has stimulated interests in molecular sieving and desalination applications. Most GO membranes prepared from existing methods are mechanically fragile, and therefore require additional support substrates which limit the water flux when used as a FO membrane.

To overcome the mechanical vulnerability as well as swelling of the stacked graphene sheets, attempts have been made to embed GO sheets in various polymer matrixes to produce flexible and stable composite membranes. Most of these polymer/GO membranes are prepared using phase-inversion methods which involve solvent/non-solvent exchange. However, the methods lead to the formation of grain boundaries (nano-corridors) and voids, and an asymmetric structure (polymer rich in one side and GO another side) cannot be avoided, and these have deleterious effects on the filtration performance drastically. To alleviate these problems, an active layer may be coated on the polymer/GO composite membrane to form a double-layer structure. However, the double layer structure, while it shows significant improvement in filtration, results in the irreversible membrane-fouling induced by internal concentration polarization (ICP) which therefore limits its use in industrial applications.

There is therefore still a need for an improved GO membrane.

### SUMMARY OF THE INVENTION

The present invention seeks to address these problems, and/or to provide an improved graphene-based membrane.

In general terms, the invention relates to a graphene-based membrane which has properties making it suitable for use in desalination. In particular, the membrane performs at least seven times (with respective to water flux) and three times (with respect to reverse salt flux) better than a commercial cellulose triacetate membrane in forward osmosis due to its smaller interlayer distance and resistance to swelling.

According to a first aspect, the present invention provides a free-standing graphene-based membrane comprising:
a plurality of partially oxidised few-layer graphene (POFG) sheets; and
a polymer, the polymer interconnecting the plurality of POFG sheets in a matrix.

The polymer may be any suitable polymer. In particular, the polymer may be a water-based polymer. For example, the polymer may be, but not limited to: polymethyl acrylate, polymethyl methacrylate, poly (vinyl acetate), polyacrylamide, poly(methyl-2-cyanoacrylate), or copolymers thereof.

The membrane according to any preceding claim, wherein the membrane may have a thickness of 10-25 μm.

According to a particular aspect, the membrane may have a water flux of ≥50 LMH when used in forward osmosis. According to another particular aspect, the membrane may have a reverse salt flux of ≤5 GMH when used in forward osmosis.

The POFG sheets comprised in the membrane may have a total oxygen content of 10% by elemental ratio. According to a particular aspect, the POFG sheets comprised in the membrane may have a plane-to-plane interaction dominated by van der Waals forces.

The POFG sheets comprised in the membrane may have a lateral dimension of 30-110 μm.

According to a second aspect, the present invention provides a method of forming the free-standing graphene-based membrane according to the first aspect, the method comprising:
mixing a plurality of partially oxidised few-layer graphene (POFG) sheets with a polymer solution to form a POFG/polymer composite solution;
depositing the POFG/polymer composite solution onto a surface of a substrate to form a membrane; and
peeling the membrane off the surface of the substrate.

The polymer may be any suitable polymer. For example, the polymer may be as described above in relation to the first aspect.

The mixing may comprise mixing a suitable amount of POFG and polymer solution together. In particular, the mixing may comprise mixing the POFG sheets in a polymer solution having a concentration of 5-20 vol % based on the total volume of the POFG/polymer composite solution.

The substrate onto which the POFG/polymer composite solution is deposited may be any suitable substrate. For example, the substrate may be, but not limited to, polypropylene (PP), polytetrafluoroethylene, polyether ether ketone (PEEK), polyoxymethylene, chlorinated polyvinyl chloride, polyethylene, polysulfone, polyurethane, polyvinyl fluoride, polyvinylidene fluoride (PVDF), or a combination thereof.

According to a particular aspect, the surface of the substrate onto which the POFG/polymer composite solution is deposited may be a hydrophobic surface. In particular, the surface of the substrate may have a contact angle 100°.

The method may further comprise drying the membrane prior to the peeling.

According to a particular aspect, the POFG sheets may be prepared by:
electrochemically exfoliating graphite to form intercalated graphite powder;
expanding the intercalated graphite powder to form few-layer graphene (FG); and
partially oxidising the FG with an oxidising agent for a pre-determined period of time to form POFG sheets.

The expanding may comprise thermally expanding the intercalated graphite powder.

According to a particular aspect, the partially oxidising may be carried out at room temperature. The partially oxidising may comprise quenching the oxidation reaction after the pre-determined period of time.

According to a particular aspect, the method may further comprise suspending the FG in an acidic medium prior to the partially oxidising.

According to a third aspect, the present invention provides partially oxidised few-layer graphene (POFG) sheets having a lateral dimension of 30-110 μm and wherein total oxygen content of the POFG sheets is ≤10% by elemental ratio.

In particular, the POFG sheets may have functionalised edges and a graphitic basal plane.

According to a particular aspect, the POFG sheets may be prepared by the method described above.

### BRIEF DESCRIPTION OF THE DRAWINGS

In order that the invention may be fully understood and readily put into practical effect there shall now be described by way of non-limitative example only exemplary embodiments, the description being with reference to the accompanying illustrative drawings. In the drawings:

FIG. 1 shows a schematic representation of a method of forming FG according to one embodiment of the present invention;

FIG. 2 shows a schematic representation of the POFG sheets formed according to one embodiment of the present invention as compared with GO sheets;

FIG. 3 shows a schematic representation of a forward osmosis set up;

FIG. 4 (a) shows the SEM image of exfoliated-GO, FIG. 4(b) shows the SEM image of POFG sheets according to one embodiment of the present invention, FIGS. 4(c) and (d) show the optical image of GO and POFG, respectively, FIGS. 4(e) and (f) show the histograms of GO and POFG, respectively, FIG. 4(g) shows the FTIR spectra of FG, POFG and GO and FIG. 4(h) shows powder-XRD analysis of GO and POFG;

FIG. 5 shows the thermo gravimetric analysis (TGS) of GO and POFG;

FIG. 6 shows the schematic representation of POFG/acryl membrane drying process according to one embodiment of the present invention;

FIG. 7 shows the comparative FO performance in terms of water flux (FIGS. 7a-c) reverse salt flux (FIGS. 7 d-f); and

FIGS. 8(a) and (b) show the SEM images of pure acryl, FIGS. 8(c) and (d) show the SEM images of GO/acryl (7 vol %) and FIGS. 8(e) and (f) show the SEM images of POFG/acryl (7 vol %).

### DETAILED DESCRIPTION

As explained above, there is a need for an improved graphene-based membrane which has good mechanical strength and able to prevent swelling when wet.

In general terms, the present invention provides a graphene-based membrane, particularly a free-standing graphene-based membrane, which is stable, has a large area and exhibits high performance for desalination applications. In particular, the membrane of the present invention exhibits high water flux, low reverse salt flux and high salt rejection.

The present invention also provides a method of forming the membrane. The method may be performed at ambient conditions and using aqueous-based solutions without any organic solvents. This makes the method of the present invention environmentally friendly, safe to perform, as well as easy to scale up.

According to a first aspect, the present invention provides a free-standing graphene-based membrane comprising:
a plurality of partially oxidised few-layer graphene (POFG) sheets; and
a polymer, the polymer interconnecting the plurality of POFG sheets in a matrix.

For the purposes of the present invention, free-standing membrane is defined as a membrane which does not require any support layer or support substrate.

The polymer comprised in the membrane may be any suitable polymer. The polymer may act as a binder to link the POFG sheets together to form the membrane. In particular, the polymer laminates the POFG sheets and imparts mechanical strength and ensures structural integrity of the membrane such that the membrane is relatively free of pinholes and/or cracks.

According to a particular aspect, the polymer may be a water-based polymer. For example, the polymer may be, but not limited to: polymethyl acrylate, polymethyl methacrylate, poly (vinyl acetate), polyacrylamide, poly(methyl-2-cyanoacrylate), or copolymers thereof. In particular, the polymer may be polymethyl acrylate.

The membrane may comprise a suitable number of POFG sheets. The POGF sheets may be interconnected in a matrix by the polymer. For example, the membrane may comprise 3-6 layers of POFG sheets. The interlayer distance between the POFG sheets may be any suitable distance. For example, the interlayer distance between the POFG sheets may be ≤9 Å, 3-9 Å, 4-8 Å, 5-7 Å. In particular, the interlayer distance may be characterised by two distinct interlayer distances between the graphene planes. Even more in particular, the interlayer distances may be 3.3 Å and 8.7 Å.

The membrane may have a suitable thickness. The thickness of the membrane may be determined by the number of POFG sheets comprised in the membrane. For example, the membrane may have a thickness of 10-25 μm. In particular, the thickness of the membrane may be 10-25 μm, 12-22 μm, 15-20 μm, 17-19 μm. When the membrane is used in desalination applications, such as in forward osmosis, the interlayer thickness of the POFG sheets work synergistically to ensure sodium ion rejection and yet allow high water flux.

According to a particular aspect, the membrane may have a water flux of ≥50 LMH when used in forward osmosis. In particular, the water flux may be 50-80 LMH, 55-75 LMH, 60-70 LMH. Even more in particular, the water flux may be about 79 LMH.

According to another particular aspect, the membrane may have a reverse salt flux of 5 GMH when used in forward osmosis. In particular, the reverse salt flux may be 1-5 GMH, 2-4 GMH, 3-3.5 GMH. Even more in particular, the water flux may be about 3.4 GMH.

The POFG sheets comprised in the membrane may have suitable properties. For example, the POFG sheets may have hydrophilic edges and hydrophobic inner channels. This is as a result of the partial oxidation of the few layer graphene in which the few layer graphene sheets are oxidised at the edges therefore comprising oxygen functional groups at the edges, whilst the basal plane (i.e. inner region) remains unoxidised and is therefore relatively oxygen free. The co-existence of hydrophilic and hydrophobic tracks in the channels act synergistically to promote high water flux, because the permeation of water is mediated by the oxygenated domains (high surface tension) and its near-zero friction flow occurs through the pristine graphene regions (low surface tension). Such a special structure of the membrane ensures a higher water flux and also a high salt rejection.

The matrix of the plurality of POFG sheets may form a multilayer lamellar structure. Further, the POFG sheets comprised in the membrane may have a total oxygen content of ≤10% by elemental ratio. In view of the low oxygen content, the plane-to-plane interaction of the POFG sheets may be dominated by van der Waals forces. In particular, the unoxygenated inner core of the structure may be held by van der Waals forces. Accordingly, the matrix of POFG sheets of the membrane may be able to resist swelling in solution and maintain the interlayer distance between POFG sheets to 9 Å, thereby ensuring that the high salt rejection is maintained even when the membrane is wet.

The POFG sheets comprised in the membrane may have a lateral dimension of 30-110 μm. In particular, the lateral dimension of the POFG sheets may be 30-110 μm, 40-100 μm, 50-90 μm, 60-80 μm, 65-70 μm. Even more in particular, the lateral dimension may be 70-100 μm. With such large sized POFG sheets, the leakage path may be reduced for the movement of sub-nanometer particles such as hydrated ions through the membrane since the large lateral size and the polymer interconnecting the POFG sheets in a matrix provide the necessary cohesive force.

In view of the above, the membrane of the present invention provides the following properties: reduced leakage path for the movement of sub-nanometer particles, improved wetting properties of capillary channels within the membrane, multilayer lamellar structure with an unoxygenated core which resists swelling in solution and improved mechanical strength and structural integrity. These properties result in a high water flux, low reverse salt flux, and high flexibility and stability. Further, as the membrane is free-standing, the problem of internal concentration polarization is avoided when the membrane is used for applications such as forward osmosis.

The membrane may be used in several applications, including but not limited to, desalination, shale gas oil or wastewater treatment, removal of dyes from textile industry effluent, concentrating fruit juice in food industry, potable water filter bags.

According to a second aspect, the present invention provides a method of forming the free-standing graphene-based membrane according to the first aspect, the method comprising:
mixing a plurality of partially oxidised few-layer graphene (POFG) sheets with a polymer solution to form a POFG/polymer composite solution;
depositing the POFG/polymer composite solution onto a surface of a substrate to form a membrane; and
peeling the membrane off the surface of the substrate.

The polymer may be any suitable polymer. For example, the polymer may be as described above in relation to the first aspect.

The POFG sheets may be as described above in relation to the first aspect of the present invention.

The mixing may comprise mixing a suitable amount of POFG and polymer solution together. In particular, the mixing may comprise mixing the POFG sheets in a polymer solution having a concentration of 5-20 vol % based on the total volume of the POFG/polymer composite solution. Even more in particular, the mixing may comprise mixing the POFG in a polymer solution having a concentration of 7-9 vol % based on the total volume of the POFG/polymer composite solution. According to a particular embodiment, the mixing may comprise mixing 7 vol % polymer and 93 vol % POFG sheets based on the total volume of the POFG/composite solution formed from the mixing.

The mixing may further comprise stirring the POFG/polymer composite solution to ensure complete mixing of the components of the composite solution. The mixing may be carried out at room temperature.

The depositing may be by any suitable method. For example, the depositing may be by, but not limited to: drop casting, bar coating, spray coating, dip coating, spin coating, or a combination thereof.

The substrate onto which the POFG/polymer composite solution is deposited may be any suitable substrate. For example, the substrate may be, but not limited to, polypropylene (PP), polytetrafluoroethylene, polyether ether ketone (PEEK), polyoxymethylene, chlorinated polyvinyl chloride, polyethylene, polysulfone, polyurethane, polyvinyl fluoride, polyvinylidene fluoride (PVDF), or a combination thereof.

According to a particular aspect, the surface of the substrate onto which the POFG/polymer composite solution is deposited may be a hydrophobic surface. In particular, the surface of the substrate may have a contact angle 100°.

The method may further comprise drying the membrane prior to the peeling. The drying may be under suitable conditions. In particular, the drying may be at room temperature. The drying may be for a suitable period of time. In particular, the drying may be for about 24 hours.

The method of forming the membrane of the present invention is an environmentally friendly method since no organic solvents and no heating is required. The method is carried out using aqueous-based solvents which are easily available and easy to handle. The method is also carried out at room temperature. Accordingly, the method is a low-cost method, scalable and safe method.

The POFG sheets may be prepared by any suitable method. In particular, the POFG sheets may be prepared by:
electrochemically exfoliating graphite to form intercalated graphite powder;
expanding the intercalated graphite powder to form few-layer graphene (FG); and
partially oxidising the FG with an oxidising agent for a pre-determined period of time to form POFG sheets.

The electrochemically exfoliating graphite to form intercalated graphite powder may be carried out in a chamber. In particular, the graphite may be used as a negative electrode and electrochemically charged at a suitable voltage in a suitable electrochemical solvent. For example, the electrochemical solvent may be LiClO₄ in propylene carbonate. The expanded graphite may then be removed and mixed with suitable solvents such as, but not limited to, dimethyl formamide (DMF), N-methyl-2-pyrrolidone (NMP) or combinations thereof, before being sonicated to obtain intercalated graphite powder. The intercalated graphite powder may be washed and collected by any suitable separation method, such as centrifugation and/or filtration.

The expanding may comprise thermally expanding the intercalated graphite powder. According to a particular aspect, the expanding may comprise using a suitable heat source, such as, but not limited to, a domestic microwave oven, hot plate, thermal oven, furnace, or a combination thereof.

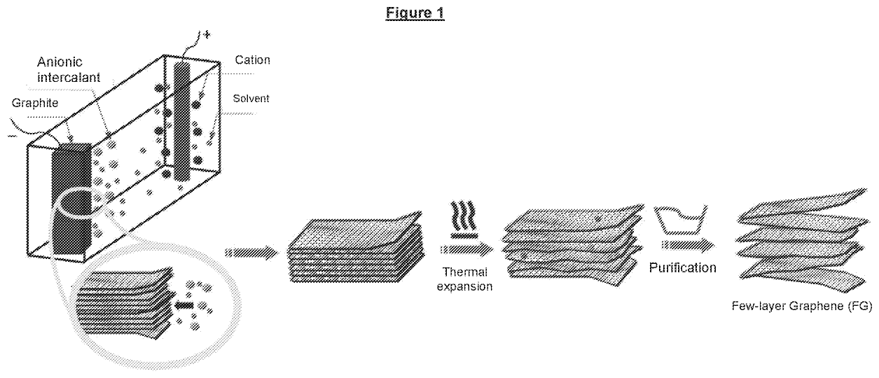

A schematic representation of the formation of the FG sheets is shown in FIG. 1.

The partially oxidising may comprise suspending the FG sheets in an acidic medium. For example, the acidic medium may comprise, but is not limited to, H₂SO₄, H₃PO₄, or a mixture thereof. The suspension of the FG in the acidic medium may be stirred for a suitable period of time. The oxidising agent added to the mixture may be any suitable oxidising agent. For example, the oxidising agent may be, but not limited to, KMnO₄, KClO₃, NaNO₃, or a combination thereof. The mixture may be continuously stirred.

The pre-determined period of time may comprise any suitable period of time for partially oxidising the FG. For example, the pre-determined period of time may be 1-3 hours. In particular, the pre-determined period of time may be 1.5-2.5 hours, 1.75-2.25 hours. Even more in particular, the pre-determined period of time may be 1 hour.

According to a particular aspect, the partially oxidising may be carried out at room temperature.

The partially oxidising may comprise quenching the oxidation reaction after the pre-determined period of time. The quenching may be by using any suitable quenching agent. For example, the quenching agent may be, but not limited to, hydrogen peroxide.

The method may further comprise washing via centrifugation following the quenching to obtain the POFG sheets.

The POFG sheets obtained from the method have a large lateral dimension. In particular, the lateral dimension of the POFG sheets obtained may be about 70-110 μm. By way of the method described above for preparing the POFG sheets, the oxidation process of the FG is controlled, thereby enabling preparing POFG sheets with edge functionalisation while maintaining pristine graphitic basal plane. In particular, the total oxygen content of the POFG sheets is 10% by elemental ratio. With the controlled oxidation involved in the method, the interlayer distance in the POFG sheets may be characterised by two distinct interlayer distances of 3.3 Å and 8.7 Å. This enables size-exclusion of ions, such as Na⁺, due to the smaller interlayer distance while the bigger interlayer distance, created by the ionic interactions by oxygenated surfaces at the edges, helps to improve water flux.

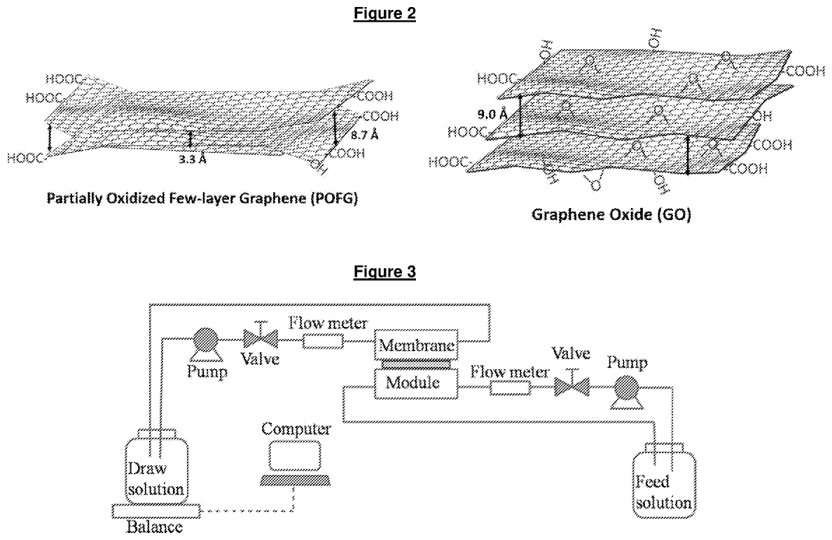

A schematic representation of the POFG sheets obtained is shown in FIG. 2. FIG. 2 also shows a comparison of the POFG sheets obtained from the method of the present invention with a GO sheet made from the conventional method (as described in the example below).

According to a third aspect, the present invention provides partially oxidised few-layer graphene (POFG) sheets having a lateral dimension of 30-110 μm and wherein total oxygen content of the POFG sheets is ≤10% by elemental ratio.

According to a particular aspect, the lateral dimension of the POFG sheets may be 30-110 μm, 40-100 μm, 50-90 μm, 60-80 μm, 65-70 μm. In particular, the lateral dimension may be 70-100 μm.

In particular, the POFG sheets may have functionalised edges and a graphitic basal plane. Accordingly, the POFG sheets have hydrophilic edges with a hydrophobic basal plane.

The total oxygen content of the POFG sheets may be 10% by elemental ratio.

The POFG sheets may comprise a suitable number of layers of partially oxidised graphene sheets. For example, the POFG sheets may comprise 3-6 layers of partially oxidised graphene sheets. Further, the interlayer distance in the POFG sheets may be ≤9 Å. In particular, the interlayer distance in the POFG sheets may be characterised by two distinct interlayer distances of 3.3 Å and 8.7 Å.

According to a particular aspect, the POFG sheets may be prepared by the method described above.

Having now generally described the invention, the same will be more readily understood through reference to the following embodiment which is provided by way of illustration, and is not intended to be limiting.

### EXAMPLES

### Example 1

### Synthesis of Graphene Oxide (GO)

GO was synthesized from graphite through the conventional “modified-Hummers' method” (Erkka J F et al, 2015, Nanotubes and Carbon Nanostructures, 23:755-759). 1 g of graphite flakes (Asbury Carbons Ltd.) and 1 g of NaNO₃ were taken in 500 mL round bottom flask and 45 mL of concentrated H₂SO₄ was added to it. This mixture was allowed to stir for a few hours (3-4 hours). Then 6 g of KMnO₄ was added slowly to the mixture at ice bath, to avoid rapid heat evaluation. After 4 hours, the flask was shifted to an oil bath and the reaction mixture was allowed to stir at 35° C. for 2 hours then temperature was increased to 60° C. to stir for 4 hours. Finally, 40 mL of water was added to the reaction mixture (very slowly) and allowed to stir at 90° C. for 1 hour and the reaction was ended by the addition of 10 mL of 30% H₂O₂ which resulted in the change of colour from yellow to brown. The warm solution was then filtered and washed with 5% HCl and DI water. Later, the filter cake was dissolved in DI water and sonicated for 2 hours to exfoliate the oxidised graphene. The solution was centrifuged first at 1000 rpm for 2 min to remove all the visible graphite particles, and later centrifuged at 13000 rpm for 2 hours. The procedure continued till the pH of supernatant become 4-5.

### Synthesis of a Few-Layer Graphene (FG)

Graphite rock (˜0.5 Kg, <10Ω) was used as the negative electrode and electrochemically charged at a voltage of 15±5 V in a 30 mg/ml solution of LiClO₄ in propylene carbonate (PC). Carbon rod (or lithium flake) was used as the positive electrode. During the electrochemical charging, HCl/DMF solution was used to remove the solid by-products. Following the electrochemical charging, the expanded graphite was transferred into a glass Suslick cell (15 ml), followed by the addition of 50 mg/ml of LiCl in dimethylformamide (DMF) solution (10 ml), PC (2 ml) and trimethylamine (TMA) (1 ml). The mixture was then sonicated for >10 hours (70% amplitude modulation, Sonics VCX750, 20 kHz) with an ultrasonic intensity of ˜100 W/cm². The sonicated graphene powder was washed by HCl/DMF and several polar solvents of DMF, ammonia, water, isopropanol and tetrahydrofuran (THF), respectively. The grey-black graphene powder was collected by centrifugation and/or filtering during the washing. Domestic microwave oven (Panasonic, 1100 W) was used to aid with the expansion of the graphite flakes to form a few-layer graphene (FG).

### Synthesis of Partially Oxidised Few-Layer Graphene (POFG)

1 g of few-layer graphene (FG) was suspended in 100-150 ml, particularly about 100 ml, of concentrated H₂SO₄/H₃PO₄ (90:10 mL) and stirred for 30-45 minutes after which 5-7 g, particularly about 5.6 g, KMnO₄ was added slowly to the mixture followed by stirring at room temperature for 0.5-3 hours, particularly 0.5-2 hours. Later, the reaction was quenched using 30% H₂O₂ (5-7 ml, particularly about 5 ml) and washed via centrifugation at 10000 rpm till the pH of the supernatant reaches 4-5. Using the same reaction conditions, this method may be scaled up easily to more than 1 kg. The as-obtained POFG flakes had a typical thickness of 2.5-4.7 nm (corresponding to 3-5 layers) with a yield of about 35-40%.

### Synthesis of GO/Polymer Composites

GO/polymer composite solutions were prepared by blending GO with different amounts of water-based polymer solution (5-20 vol %). For example, 7 vol % GO/polymer composite prepared by mixing 0.7 ml of polymer solution into 9.3 ml of GO (2 mg/ml) solution and stirred at room temperature for 24 hours.

### Fabrication of GO/Polymer Free-Standing Membrane

As prepared GO/polymer composite solutions were casted on a polypropylene-coated surface and allowed it to dry at room temperature for 24 hours. Finally, free-standing GO/polymer membrane was peeled-off the from the polymer surface.

### Synthesis of POFG/Polymer Composites

POFG/polymer composite solutions were prepared by blending POFG with different amounts of water-based polymer, particularly polymethyl acrylate solution (5-20 vol %). For example, 7 vol % POFG/polymer composite prepared by mixing 0.7 ml of polymer solution into 9.3 ml of POFG (2 mg/ml) solution and stirred at room temperature for 20-24 hours.

### Fabrication of POFG/Polymer Free-Standing Membrane

As prepared POFG/polymer composite solutions were casted on a polypropylene-coated surface and allowed to dry at room temperature for 24 hours. Finally, free-standing POFG/polymer membrane was peeled-off the from the polymer surface.

### Evaluation of Membrane Performance for FO

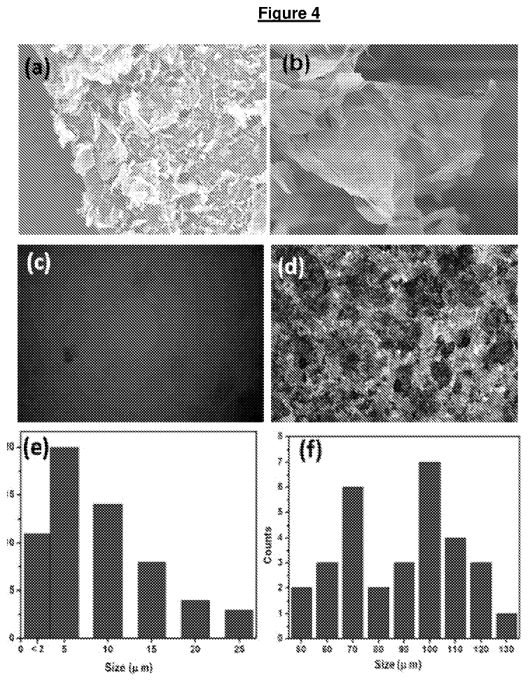

Osmotic-driven membrane desalination performance was evaluated using laboratory scale FO setup as shown in FIG. 3. It consisted of a membrane test module with one water channel on each side of the membrane with a dimension of 2.0 cm in length and 1.0 cm in width. The effective membrane area was 2.0 cm². No spacer was used in the testing. Both draw solution (2 M NaCl) and feed solution (DI water) flowed, in a counter-current mode, through the filtration cell at the same volumetric flow rate of 0.3 L/min, and the solutions were re-circulated.

The water permeation flux, J, (L/m₂/h, LMH), was determined by Equation (1) on the basis of the absolute weight change of the feed and the effective membrane area, Aₘ (m²):

$${J}_{w} = \frac{Δ w}{{A}_{m} Δ t} \qquad ( 1 )$$

where Δw (kg) is the absolute weight change of water that has permeated across the membrane over a pre-determined time Δt (h) during the FO tests.

The reverse salt flux, JS (g/m²/h, GMH) was determined from the conductivity increment in the feed when deionised water was used as the feed solution:

$${J}_{s} = \frac{( {C}_{t} {V}_{t} ) - ( {C}_{o} {V}_{o} )}{{A}_{m} Δ t} \qquad ( 2 )$$

where Cₜ (mol/L) and Vₜ (L) are the salt concentration and the volume of the feed solution at time t, respectively; C₀ (mol/L) and V₀ (L) are the initial salt concentration and the volume of the feed solution, respectively.

### Results and Discussion

There are three possible pathways for the movement of sub-nanometer particles (e.g. hydrated ions) through stacked sheets of GO, namely: the ions can diffuse through pores, through inter-edge areas and/or interlayer nanochannels. It is difficult to control the size of the pores and the inter-edge areas, so using large GO sheets with lateral size >100 μm, along with a binding material to provide the necessary cohesive forces, can reduce unwanted leakage paths. To improve the filtration properties further, the wetting properties of the capillary channels can be tuned by chemical treatment. The hydrophilic and hydrophobic tracks in the channels act synergistically to enhance a high water flux, whereby the permeation of water is mediated by the oxygenated domains (high surface tension) and its near-zero friction flow occurs through the pristine graphene regions (low surface tension).

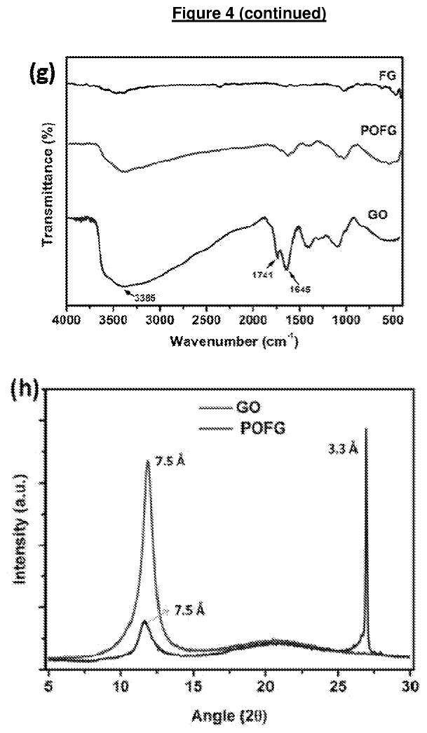

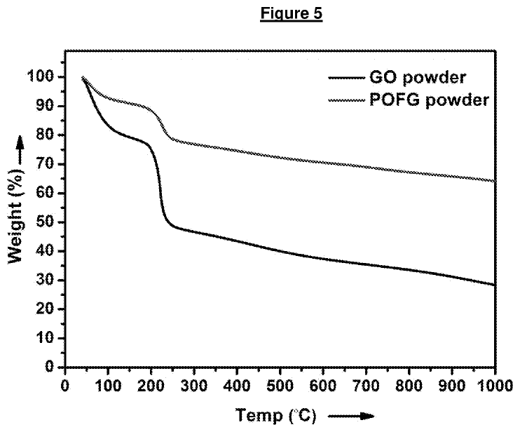

In order to study the correlation between hydrophobicity in the channels and FO performance, two types of GO were synthesized, namely fully oxidised GO and partially oxidised few-layer graphene (POFG) as described above. Scanning Electron Microscopy (SEM) and optical images in FIG. 4(a)-(f) shows that POFG sheets have larger flake-size distribution (70-110 μm) compared to that of GO (2-15 μm), this is because its preparation avoids the vigorous oxidation conditions that causes fragmentation in GO sheets. POFG flakes have typical thickness of 2.5 to 4.7 nm as determined by AFM, which corresponds to between 3 to 5 layers of graphene. The differing degrees of oxidation in GO and POFG have been investigated by Fourier Transform Infrared (FTIR) analysis. FIG. 4(g) shows that the intensities of peaks corresponding to C═O (1741 cm⁻¹) and —OH (3385 cm⁻¹) vibrations are lower in POFG compared to fully-oxidised GO. This is also supported by the thermo gravimetric analysis (TGA) data of GO and POFG (See FIG. 5) where POFG shows higher thermal stability than that of GO. The milder oxidation process used in the preparation of POFG enabled achieving edge functionalization while maintaining pristine graphene basal plane.

The presence of oxygen functional groups on the basal plane of GO imposes steric repulsion effects, which causes the interlayer distance in stacked GO sheets to widen. Thus both hydrophilic effects and a wider interlayer distance will cause a greater infiltration of water in GO compared to the POFG samples. The interlayer distances of POFG and GO have been investigated using powder XRD. As shown in FIG. 4(h), the interlayer spacing in restacked GO sheets is 7.5 Å. The XRD spectrum of POFG in FIG. 4(h) show two peaks, this is consistent with its partially reduced nature, in which the interlayer spacing of 7.5 Å corresponds to the oxidized edges, which is similar to that present in the oxidised GO, and the 3.3 Å spacing is characteristic of tightly packed graphene layers in the inner regions. The minimum cut-off interlayer space to block monovalent hydrated ions is 6.4 Å and 7.2 Å for K⁺ and Na⁺ respectively, thus POFG may offer size-exclusion effects to hydrated ions due to its smaller interlayer spacing.

Furthermore, it was very important to confirm the swelling behaviour of GO and POFG films in water to check the reliability of their membranes for practical usage. The GO and POFG free-standing films were soaked for 4 days in deionized water and the swelling behaviour was visually captured by the optical spectroscope. It was observed that the increase in thickness of POFG was about two times smaller (thickness change from 33.8 μm to 75.3 μm) compared to that of GO (thickness change from 33.3 μm to 116.3 μm). This confirmed that the smaller inter-plane distance as well as larger hydrophobicity of POFG.

To confirm the changes in inter-layer spacing, XRD analysis of these samples were carried out after immersion in water, where the interlayer spacing in GO was found to increase from 7.5 Å to 9 Å. POFG film was characterized by two interlayer spacings, and it was found that there was only a 0.5 Å increment in POFG film for the 7.5 Å peak and an insignificant change for the 3.3 Å peak, thus confirming that the smaller interlayer spacing in POFG resisted swelling.

To improve the stability of GO-based membranes, polymer matrixes (PES, PVDF, PSf) were prepared using the phase-inversion preparation method previously used to form composites with GO. Even though the water flux of the composite membranes was improved, the salt-rejection property was poor due to the presence of microvoids and grain boundaries. In addition, the phase-segregation of GO occurred due to hydrophilic (GO)/hydrophobic (polymer) incompatibility, which created voids on one side and dense layer on another side, leading to internal concentration polarization (ICP) in ionic solutions. There was a need to identify a polymer which could form void-free interface with GO and allow homogeneous distribution of GO in it. An acrylic-based water soluble polymer which can be cured by a room temperature drying process was therefore selected.

### Fabrication Process of GO or POFG/Acryl Membrane (Acryl Sealing Process)

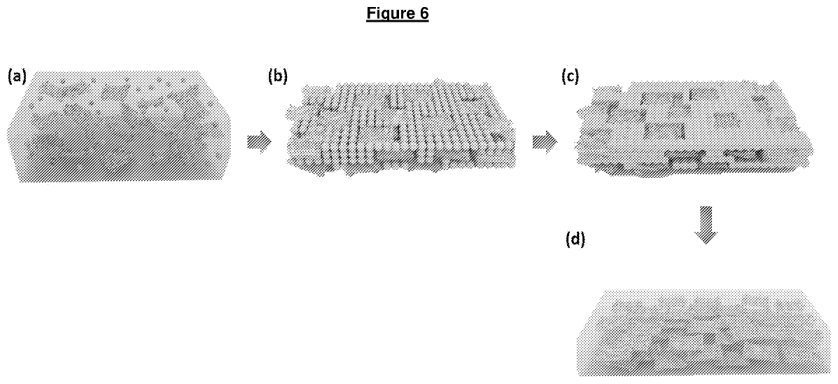

The same membrane fabrication process applied to both GO or POFG, and using either GO or POFG allowed the study of the role of hydrophobicity/hydrophilicity in desalination. In the first step, POFG/acryl composite solution was cast on polypropylene-coated surface and allowed to dry for 24 hours at room temperature. The typical drying process of this polymer is as shown in FIG. 6 and involves evaporation of solvent (water), which led to the formation of microscopic acrylic polymer spheres. Subsequently, the spheres self-assembled into a honeycomb-like pattern by capillary forces, the attractive forces between the spheres led to the deformation and coalescence of the spheres.

As shown in FIG. 6, acrylic polymer spheres bound onto POFG surface via hydrogen bonding interactions and polar-polar interactions between the ester groups of polyacrylate and oxygen functionalities of POFG sheets. Upon solvent evaporation, the polymer spheres coalesced and laminated the embedded POFG into a continuous POFG/acryl cohesive film. The air-dried membrane film was subsequently peeled-off from polypropylene surface which was ready to be tested without any further modifications. The advantage of this method is its scalability. POFG/acryl membranes of different compositions were fabricated by varying the composition of acryl to POFG (5 vol % to 20 vol % of acryl in POFG) and tested for FO performance. The results of the FO performance are shown in Table 1.

TABLE 1
Results of different membrane when used in FO process with 2M NaCl
solution and DI water as draw and feed solutions respectively

| Membrane | Water flux (LMH) | Reverse salt flux (GMH) |
|---|---|---|
| GO | Not stable | Not stable |
| GO/Acryl (5 vol %) | Not stable | Not stable |
| GO/Acryl (7 vol %) | 32.5 | 7.5 |
| GO/Acryl (10 vol %) | 11.0 | 1.4 |
| GO/Acryl (20 vol %) | 10.0 | 1.3 |
| Pure Acryl | 15.6 | 348.0 |

### GO/Polyethersulfone (PES) Membrane Fabrication

For comparison, GO-PES membrane was fabricated via standard phase-inversion method. In a typical process, a GO-PES composite solution (e.g. GO (1 wt %)+PES (20 wt %)+Polyvinylpyrrolidone (1 wt %)+DMF solvent) was cast on a supporting layer (glass) and then submerged in a coagulation bath containing non-solvent (DI water). Due to the solvent and non-solvent exchange, precipitation takes place. As prepared membranes from above two processes (Acryl sealing and phase-inversion) were tested in FO using 2M NaCl solution as draw and DI water as feed solution.

### Forward Osmosis Performance

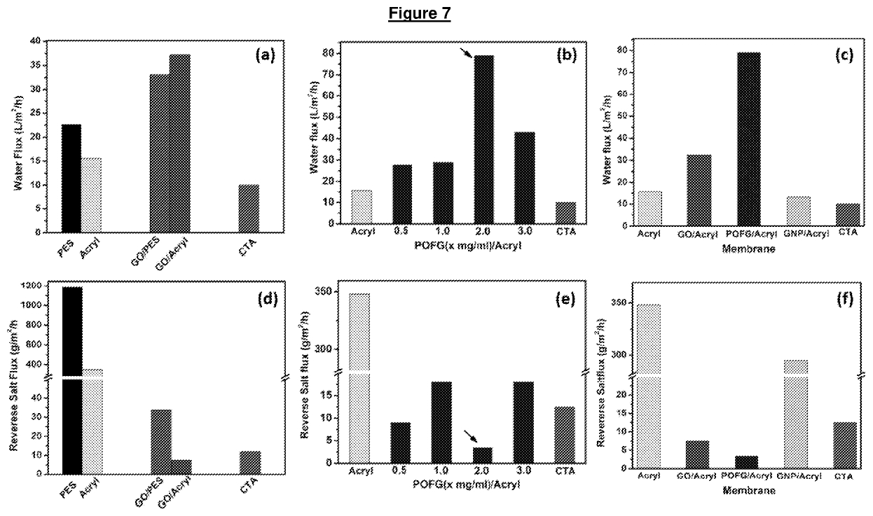

FIG. 7 shows the water flux and reverse salt flux performance of various membranes, and the active testing area for FO was standardized at 2 cm² for all. In general, a high water flux has to be matched by a low reverse salt flux for good desalination performance. Desalination membrane prepared via acryl sealing process (GO/acryl) showed a lower salt permeation (7.5 g/m²/h) (FIG. 7(d)) compared to membranes prepared using the phase-inversion method (GO/PES, 33.6 g/m²/h) and also commercial cellulose triacetate (CTA) membrane (12 g/m²/h). The superior performance of POFG/acryl membrane can be attributed to the efficient sealing ability of acryl binder at the POFG-acryl interface. Pure acrylic polymer membrane had a much lower water flux than GO-acryl (FIG. 7(a)) and POFG-acryl composite membrane (FIG. 7(c)), which means that water permeated mostly through the GO or POFG interlayer channels. The efficient sealing ability between POFG and acryl is due to their functional group interactions and compatibility. The salt rejection ability is ascribed to the interlayer distance in confined POFG, which affords the appropriate size exclusion effect for hydrated Na⁺. In contrast, in the case of GO/PES membrane, salt ions permeates through both voids created at GO-PES interface and the PES matrix, leading to a higher salt leakage compared to GO/Acryl membrane.

The hydrophilicity of GO allowed highly efficient permeation of water molecules, hence it is unsurprising to see improvement in water flux for both GO/PES and GO/acryl membranes compared to the polymer-alone membranes (PES, acryl membranes respectively). As shown in FIG. 7(a), GO/acryl membrane (37.2 L/m²/h) showed better water permeability compared to GO/PES membrane (33.1 L/m²/h). The improved water flux in GO/acryl membrane was attributed to its symmetric membrane structure with uniform dispersion of GO sheets, which created a network of channels for water transport. In contrast, in GO/PES, the membrane phase segregated into polymer-rich hydrophobic regions and hydrophilic regions, which created a larger diffusion barrier for water transport. The asymmetric structure in GO/PES membrane further led to internal concentration polarisation (ICP) which also affected the water permeability. Hence, acryl-laminated GO membranes showed better performance in desalination compared to GO membrane made by conventional phase-inversion method. The acryl-lamination method was further extended to different types of graphene derivatives: POFG and graphene nanoplatelets (GNP).

The effect of hydrophobicity of the GO on the FO performance was investigated next. FIG. 7(c) shows that POFG/acryl membrane shows the highest water flux (79 L/m²/h) (at optimised composition, FIGS. 7(b, e)) and lowest reverse salt flux 3.4 g/m²/h among all composite membranes tested (FIG. 7(f)), including GO/acryl (32.5 L/m²/h and 7.5 g/m²/h), GNP/acryl (13.2 L/m²/h and 294.8 g/m²/h) and commercial membrane cellulose triacetate (CTA) (water flux 10 L/m²/h, reverse salt flux 12 g/m²/h).

The good performance of POFG stems from several unique features: its flake size is much larger, and it also has larger regions of hydrophobic channels compared to fully-oxidized GO. Non-oxidised nanochannels in GO allow for friction-free water transport across the membrane. The salt-retention performance of POFG/acryl membrane may also be attributed to its large flake-size and close-packing structure which presents more trapping sites for ions compared to fully oxidised GO that has a relatively loose packing structure. It has to be pointed out that if unoxidized graphite nanoplatelets (GNP) was used to make a GNP/acryl composite FO membrane following similar method as POFG/acryl, a much poorer performance would be obtained instead, which suggests that a minimum concentration of oxygen functionalities is required to help with dispersion of the flake and also to allow a high water flux.

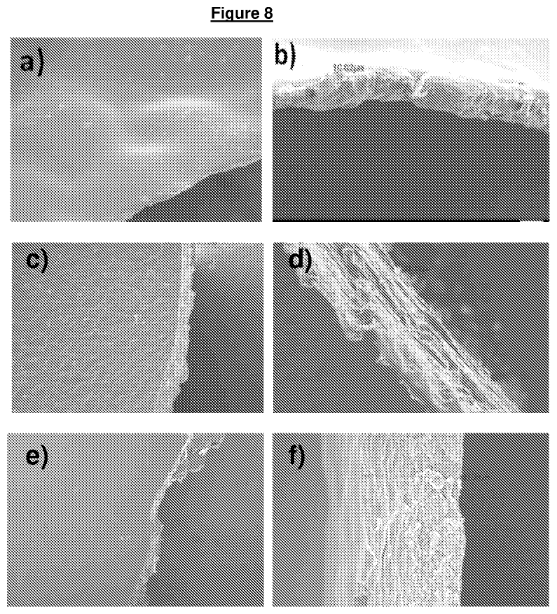

FIG. 8 shows the surface and cross-sectional morphologies of pure acryl, GO/acryl and POFG/acryl membranes respectively. Compared to POFG/acryl membrane, the surface of GO/acryl membrane (FIG. 8 (c)) appears to be rough, which is due to the more convoluted, disordered stricture of the restacked GO sheets present in acryl matrix. In contrast, a very smooth surface was observed for POFG/acryl membrane (FIG. 8(e)). The larger sized POFG and its stronger t-t stacking (and hence smaller interlayer distance) may be responsible for the highly ordered layered stacking structure of POFG. Probing the inner structure of the membrane was needed in order to understand the variation of performance among the different composite membranes.

Using cross-section SEM, it was observed that pure-acryl (FIG. 8 (a), (b)) membrane does not have a layered structure, in contrast, the cross-sectional morphologies of GO/acryl and POFG/acryl composite membranes (FIG. 8 (d), (f)) reveal lamellar structure in GO and POFG membranes.

Whilst the foregoing description has described exemplary embodiments, it will be understood by those skilled in the technology concerned that many variations may be made without departing from the present invention.

1. A free-standing graphene-based membrane comprising:
a plurality of partially oxidised few-layer graphene (POFG) sheets; and
a polymer, the polymer interconnecting the plurality of POFG sheets in a matrix.

2. The membrane according to claim 1, wherein the polymer is a water-based polymer.

3. The membrane according to claim 1, wherein the polymer comprises: polymethyl acrylate, polymethyl methacrylate, poly (vinyl acetate), polyacrylamide, poly(methyl-2-cyanoacrylate), or copolymers thereof.

4. The membrane according to claim 1, wherein the membrane has a thickness of 10-25 μm.

5. The membrane according to claim 1, wherein the membrane has a water flux of ≥50 LMH when used in forward osmosis.

6. The membrane according to claim 1, wherein the membrane has a reverse salt flux of ≤5 GMH when used in forward osmosis.

7. The membrane according to claim 1, wherein the POFG sheets have a total oxygen content of ≤10% by elemental ratio.

8. The membrane according to claim 1, wherein the POFG sheets have a plane-to-plane interaction dominated by van der Waals forces.

9. The membrane according to claim 1, wherein the POFG sheets have a lateral dimension of 30-110 μm.

10. A method of forming the free-standing graphene-based membrane according to claim 1, the method comprising:
mixing a plurality of partially oxidised few-layer graphene (POFG) sheets with a polymer solution to form a POFG/polymer composite solution;
depositing the POFG/polymer composite solution onto a surface of a substrate to form a membrane; and
peeling the membrane off from the surface of the substrate.

11. The method according to claim 10, wherein the polymer is a water-based polymer.

12. The method according to claim 10, wherein the polymer comprises: polymethyl acrylate, polymethyl methacrylate, poly (vinyl acetate), polyacrylamide, poly(methyl-2-cyanoacrylate), or copolymers thereof.

13. The method according to claim 10, wherein the mixing comprises mixing the POFG sheets in a polymer solution having a concentration of 5-20 vol % based on the total volume of the POFG/polymer composite solution.

14. The method according to claim 10, wherein the depositing comprises depositing the POFG/polymer composite solution onto a hydrophobic surface of a substrate.

15. (canceled)

16. (canceled)

17. The method according to claim 10, wherein the method further comprises drying the membrane prior to the peeling.

18. The method according to claim 10, wherein the POFG sheets are prepared by:
electrochemically exfoliating graphite to form intercalated graphite powder;
expanding the intercalated graphite powder to form few-layer graphene (FG); and
partially oxidising the FG with an oxidising agent for a pre-determined period of time to form POFG sheets.

19. The method according to claim 18, wherein the expanding comprises thermally expanding the intercalated graphite powder.

20. The method according to claim 18, wherein the partially oxidising is carried out at room temperature.

21. (canceled)

22. (canceled)

23. Partially oxidised few-layer graphene (POFG) sheets having a lateral dimension of 30-110 μm and wherein total oxygen content of the POFG sheets is ≤10% by elemental ratio.

24. (canceled)

25. The POFG sheets according to claim 23, wherein the POFG is prepared by:
electrochemically exfoliating graphite to form intercalated graphite powder;
expanding the intercalated graphite powder to form few-layer graphene (FG);
partially oxidising the FG with an oxidising agent for a pre-determined period of time to form the POFG sheets.
